(19) United States
(12) Patent Application Publication
(10) Pub. No.: US 2021/0383147 A1
(43) Pub. Date: Dec. 9, 2021

(54) METHODS AND SYSTEMS FOR TRANSLATING FIDUCIAL POINTS IN MULTISPECTRAL IMAGERY

(71) Applicant: Booz Allen Hamilton Inc., McLean, VA (US)

(72) Inventors: Srinivasan RAJARAMAN, Laurel, MD (US); Nathaniel Jackson SHORT, Annapolis, MD (US); Shuowen HU, Adelphi, MD (US); Matthew THIELKE, Adelphi, MD (US); Robert NGUYEN, Laurel, MD (US)

(73) Assignee: Booz Allen Hamilton Inc., McLean, VA (US)

(21) Appl. No.: 16/895,846

(22) Filed: Jun. 8, 2020

(51) Int. Cl. G06K 9/20; G06K 9/00

(52) U.S. Cl. CPC G06K 9/2054; G06K 9/00221; G06K 9/00201

(57) ABSTRACT

A method and system for translating fiducial points in multispectral imagery includes capturing a first image of an object by a first imaging device in a first spectral domain, the first spectral domain being the visible spectrum; capturing a second image of the object by a second imaging device in the first spectral domain; capturing a third image of the object by a third imaging device in a second spectral domain, the second spectral domain being outside the visible spectrum; determining three-dimensional location information of one or more fiducial points of the object based on the first and second visible spectrum images; projecting the one or more fiducial points from the three-dimensional image of the object onto an two-dimensional image plane of the third image; and translating the location of the one or more fiducial points of the object from first and second visible spectrum images to the third image.

This invention was made with U.S. Government support under contract No. W911QX-17-D-0015 awarded by the U.S. Army. The U.S. Government has certain rights in this invention.

### TECHNICAL FIELD

The present disclosure relates to methods and systems for translating fiducial points in multispectral imagery, specifically translating three-dimensional location information for one or more fiducial points of an object from images in a first spectral domain to images in a second spectral domain.

### BACKGROUND

Facial recognition research has been actively pursued, primarily in the visible spectrum, over the past several decades with applications in commercial, military, healthcare, and government sectors. A crucial step in the face recognition process is face registration, which requires alignment of a probe and gallery facial images to canonical coordinates using a set of fiducial landmarks, such as the center of the eyes, tip of the nose, corners of the mouth, etc. Inaccurate landmark positions result in incorrect semantic alignment between faces or their higher-level contextual features, which can result in matching or classification errors. Therefore, face alignment research has been actively pursued in the visible domain for some time. As a result, there has been significant advances in the face alignment research in visible spectrum, allowing accurate face landmark detection in images under varying illumination, occlusion, and poses due, in part, to deep learning-based algorithms using convolutional neural network (CNN) approaches and the availability of large databases of visible facial images with manually annotated landmark points. Facial recognition in the visible spectrum is affected by different lighting and illumination conditions and as such is impractical for nighttime face recognition. Thus, there is a need for a technical solution for facial recognition in domains outside the visible spectrum.

### SUMMARY

A first method for translating fiducial points in multispectral imagery is disclosed. The first method includes capturing a first image of a three-dimensional object by a first imaging device in a first spectral domain, the first spectral domain being the visible spectrum; capturing a second image of the three-dimensional object by a second imaging device in the first spectral domain; capturing a third image of the three-dimensional object by a third imaging device in a second spectral domain, the second spectral domain being outside the visible spectrum; determining three-dimensional location information of one or more fiducial points of the three-dimensional object based on the first and second visible spectrum images; projecting the one or more fiducial points from the three-dimensional image of the three-dimensional object onto an two-dimensional image plane of the third image; and translating the location of the one or more fiducial points of the three-dimensional object from first and second visible spectrum images to the third image.

A first system for translating fiducial points in multispectral imagery is disclosed. The first system includes a first imaging device in a first spectral domain configured to capture a first image of a three-dimensional object, the first spectral domain being the visible spectrum; a second imaging device in the first spectral domain configured to capture a second image of the three-dimensional object; a third imaging device in a second spectral domain configured to capture a third image of the three-dimensional object, the second spectral domain being outside the visible spectrum; and a processor configured to determine three-dimensional location information of one or more fiducial points of the three-dimensional object based on the first and second visible spectrum images, project the one or more fiducial points from the three-dimensional image of the three-dimensional object onto an two-dimensional image plane of the third image, and translate the location of the one or more fiducial points of the three-dimensional object from first and second visible spectrum images to the third image.

A second method for translating fiducial points in multispectral imagery is disclosed. The second method includes capturing a first image of a three-dimensional object by a first imaging device in a first spectral domain, wherein the first imaging device is a three-dimensional imaging device; capturing a second image of the three-dimensional object by a second imaging device in a second spectral domain, the second spectral domain being different from the first spectral domain; determining three-dimensional location information of one or more fiducial points of the three-dimensional object based on the first image; projecting the one or more fiducial points from the three-dimensional image of the three-dimensional object onto an two-dimensional image plane of the second image; and translating the location of the one or more fiducial points of the three-dimensional object from first image to the second image.

A second system for translating fiducial points in multispectral imagery is disclosed. The second system includes a first imaging device in a first spectral domain configured to capture a first image of a three-dimensional object, the first spectral domain being the visible spectrum, and the first imaging device being a three-dimensional imaging device; a second imaging device in a second spectral domain configured to capture a second image of the three-dimensional object, the second spectral domain being different from the first spectral domain; and a processor configured to determine three-dimensional location information of one or more fiducial points of the three-dimensional object based on the first image, project the one or more fiducial points from the three-dimensional image of the three-dimensional object onto an two-dimensional image plane of the second image, and translate the location of the one or more fiducial points of the three-dimensional object from first image to the second image.

### BRIEF DESCRIPTION OF THE DRAWINGS

The scope of the present disclosure is best understood from the following detailed description of exemplary embodiments when read in conjunction with the accompanying drawings, wherein:

FIG. 1 is a block diagram illustrating a system for translating fiducial points in multispectral imagery in accordance with exemplary embodiments;

FIG. 2 illustrates a flowchart of a first exemplary method for translating fiducial points in multispectral imagery in accordance with exemplary embodiments.

FIG. 3 illustrates a flowchart of a second exemplary method or translating fiducial points in multispectral imagery in accordance with exemplary embodiments.

FIG. 4a illustrates an exemplary visible-range image of a face with fiducial points captured by a first visible range imaging device in accordance with exemplary embodiments.

FIG. 4b illustrates an exemplary visible-range image of a face with fiducial points captured by a second visible range imaging device in accordance with exemplary embodiments.

FIG. 4c illustrates an exemplary thermal-range image of a face captured by a thermal imaging device with fiducial points translated from the images of FIGS. 4a-4b in accordance with exemplary embodiments.

FIG. 5a illustrates an exemplary visible-range image of a face without expression with fiducial points captured by a visible range imaging device in accordance with exemplary embodiments.

FIG. 5b illustrates an exemplary thermal-range image of a face without expression captured by a thermal imaging device with fiducial points translated from the image of FIG. 5a in accordance with exemplary embodiments.

FIG. 6a illustrates an exemplary visible-range image of a face with expression with fiducial points captured by a visible range imaging device in accordance with exemplary embodiments.

FIG. 6b illustrates an exemplary thermal-range image of a face with expression captured by a thermal imaging device with fiducial points translated from the image of FIG. 6a in accordance with exemplary embodiments.

FIG. 7a illustrates an exemplary visible-range image of a face in profile with fiducial points captured by a visible range imaging device in accordance with exemplary embodiments.

FIG. 7b illustrates an exemplary thermal-range image of a face in profile captured by a thermal imaging device with fiducial points translated from the image of FIG. 7a in accordance with exemplary embodiments.

Further areas of applicability of the present disclosure will become apparent from the following detailed description. It should be understood that the detailed description of exemplary embodiments are intended for illustration purposes only and are not intended to limit the scope of the disclosure.

### DETAILED DESCRIPTION

The present disclosure provides a novel solution for facial recognition in domains outside the visible spectrum. Currently, there is a need for facial recognition technology that is largely invariant to ambient lighting and useful for providing a passive day and night-time face recognition capability. Further, cross-spectrum face recognition, such as thermal-to-visible face recognition, is more sensitive to face alignment errors compared to visible face recognition. Currently, face alignment algorithm development in the thermal domain is limited compared to that in the visible domain due to the lack of extensive training data in the thermal spectrum with ground-truthed fiducial landmarks. The existing datasets for training face alignment algorithms require laborious, manual annotation. Moreover, fatigue is one of the reasons that in some cases make the manual annotations inaccurate, in general. In case of thermal images, this issue is exacerbated as humans are not used to observing thermal images compared to the visible ones. Thus, there is a need to develop accurate face alignment algorithms for facial images acquired in the thermal domain.

The methods and systems provided herein provide a novel solution, not addressed by current technology, for translating the knowledge of facial fiducial points in the visible domain to corresponding thermal face imagery and other spectral domain imagery. Exemplary embodiments of the methods and systems provided for herein utilize one or more visible cameras and a thermal camera, or other spectral domain camera, spatially separated to synchronously acquire images. Embodiments of the methods and systems provided herein utilize stereo vision and multi-view geometry to determine the three-dimensional information of fiducial points of three-dimensional objects from the multi-view visible images and then project that three-dimensional information onto the image plane of the thermal camera. Embodiments of the methods and systems provided herein provide for calibration (re-sectioning) of the one or more visible cameras by calculating the intrinsics and extrinsics of the one or more visible cameras that can be used to translate the facial fiducial point information from the multiple visible images on to their synchronously-captured thermal images all at once. Thus, exemplary embodiments of the methods and systems provided herein provide for translating the knowledge of facial fiducial points in the visible domain to corresponding thermal face imagery by avoiding manual annotation. While illustrative embodiments of the methods and systems provided herein use visible and thermal spectral domains to translate fiducial points of a face, the methods and systems may also utilize other spectral domains and other objects beyond faces.

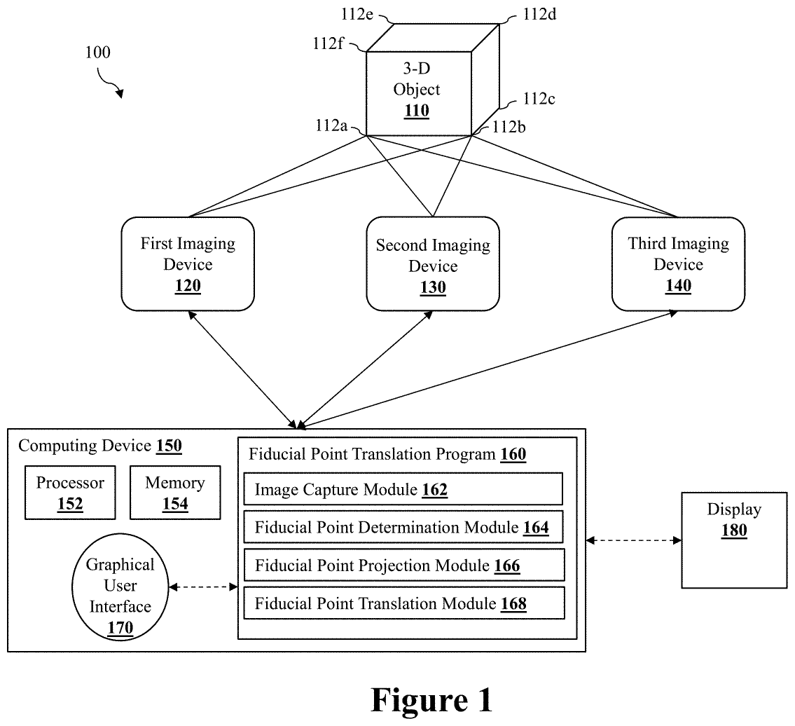

FIG. 1 illustrates an exemplary system 100 for translating fiducial points of a three-dimensional object 110 in multispectral imagery. The system 100 includes a first imaging device 120, a second imaging device 130, a third imaging device 140, a computing device 150, and a display 180. While the computing device 150 and the display 180 are illustrated as separate devices, it can be appreciated that the computing device 150 and the display 180 may be contained within a single device. Further, while a fiducial point translation program 160 and a graphical user interface 170 are illustrated as being located on a single computing device 150, it can be appreciated that any number of computing devices may be a part of the system 100 and that each computing device 150 may have a graphical user interface 170 communicating with a separate computing device 150 operating as a server for the fiducial point translation program 160.

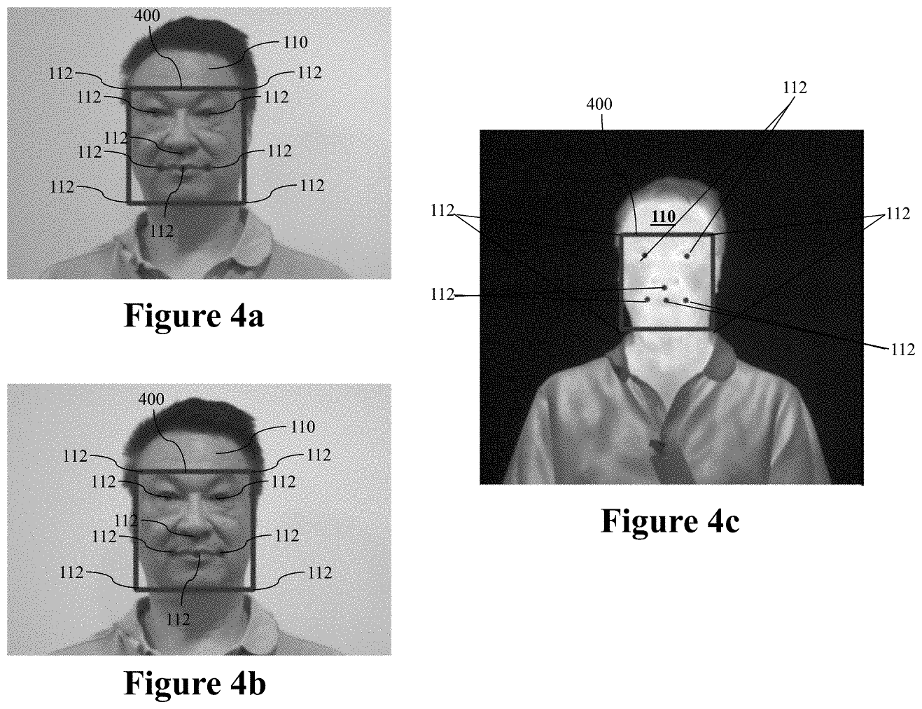

The three-dimensional object 110 can be any three-dimensional object capable of being imaged by an imaging device, such as the first imaging device 120, the second imaging device 130, and the third imaging device 140. For example, the three-dimensional object 110 can be, but is not limited to, a face, a vehicle, or a building, etc. The three-dimensional object 110 includes one or more fiducial points 112a-f. The one or more fiducial points can be features, objects, or markings, etc. on the three-dimensional object 110, which may be used as points of reference. For example, the three-dimensional object 110 may be a face and the one or more fiducial points 112a-f may be one or more facial landmarks, such as, but not limited to, the center of the eyes, the tip of the nose, the corners of the mouth, and the boundary of the face, etc. The boundary of the face may be indicated using a box 400 as illustrated in FIGS. 4a-7b around the outside of the face with each of the corners of the box being a separate fiducial point 112 which can be translated as described in more detail below to translate the box 400. While fiducial points 112a-f are illustrated as part of the three-dimensional image 110, it can be appreciated that the three-dimensional object 110 can have any number of fiducial points. As another example, the three-dimensional object 110 may be a target object such as, but not limited to, a military vehicle, a tank, a ship, a drone, and a weapon, etc., and the one or more fiducial points 112 may be unique points, e.g. corners, shapes, designs, etc., associated with those objects.

The first imaging device 120 and the second imaging device 130 can be any imaging device capable of capturing images of the three-dimensional object 110 in the visible spectrum. The first imaging device 120 and the second imaging device 130 may capture visible spectrum images of the three-dimensional object 110 in color or in monochrome, e.g. black and white. In an exemplary embodiment the first imaging device 120 and the second imaging device 130 may be monochrome visible-range cameras. In an exemplary embodiment, the first imaging device 120 and the second imaging device 130 may be spatially separated so as to exploit stereo vision and multi-view geometry to capture three-dimensional information for the one or more fiducial points 112 of the three-dimensional object 110.

In an exemplary embodiment, the first imaging device 120 and the second imaging device 130 are calibrated using known calibration techniques such as, but not limited to, geometric camera calibration such as Zhang's technique as disclosed in “A Flexible New Technique for Camera Calibration,” IEEE Transactions on Pattern Analysis and Machine Intelligence, Vol. 22, No. 1, 2000, pp. 1330-1334, herein incorporated by reference. In geometric camera calibration, also called re-sectioning, the intrinsic and extrinsic parameters of the first imaging device 120 and the second imaging device 130 are calculated in order to translate the three-dimensional location information of the one or more fiducial points 112 from one or more visible images captured by the first imaging device 120 and the second imaging device 130 on to one or more synchronously-captured alternate domain images captured by the third imaging device 140. For example, geometric camera calibration estimates the parameter of the lens and the image sensor of a camera, e.g. the first imaging device 120 and the second imaging device 130, assuming a pinhole model. The pinhole camera model is based on the principle of collinearity, where each point in the 3D world is projected by a straight line through the projection center onto the image plane as shown in. In this setup, a point P in the 3D world is projected onto the image plane at (u,v) by tracing a line from P through the lens nodal point or the camera origin point. The relationship between (u,v) and P is given by the following equation 1 where (X,Y,Z) represent the coordinates of the 3D point P in the world coordinate system, (x,y,z) represent the coordinates of the same 3D point in the camera coordinate system, (u,v) represent the coordinates of the projection of point P on the image plane in pixels, K refers to the intrinsic matrix, (Cx and Cy) represent the principal point of the image plane along the x and y direction in pixels, and likewise (fx and fy) represent the focal lengths in pixels. The parameter R and t denote the rotation and translation matrices to transform the 3D coordinates from world coordinate system to the camera coordinate system. The parameter s is an arbitrary scalar, which denotes the fact that the projection of the point P is only up to a scale. In equation 2, the parameters (fx, fy, Cx, and Cy) constitute the intrinsic parameters of the camera along with radial distortion coefficients (k1, k2, and k3) and tangential distortion coefficients (p1 and p2) that account for lens distortion, whereas the joint rotation-translation matrix is called as the matrix of extrinsic parameters.

$$\begin{matrix} s [ \begin{matrix}u \\ v \\ 1\end{matrix} ] = K [ R \vert t ] [ \begin{matrix}X \\ Y \\ Z \\ 1\end{matrix} ] , & ( Equation 1 ) \\ K = [ \begin{matrix}{f}_{x} & 0 & {C}_{x} \\ 0 & {f}_{y} & {C}_{y} \\ 0 & 0 & 1\end{matrix} ] , [ \begin{matrix}x \\ y \\ z\end{matrix} ] = R [ \begin{matrix}X \\ Y \\ Z\end{matrix} ] + \text{?} , \\ \text{?} \\ \text{?} \\ \text{?} \\ \text{?} \\ \text{?} \\ u = {x}^{′} {f}_{x} + {C}_{x} , v = {y}^{′} {f}_{y} + {C}_{y} . \\ \text{?} \text{indicates text missing or illegible when filed} & ( Equation 2 )\end{matrix}$$

While the system 100 illustrates both a first imaging device 120 and a second imaging device 130 which are positioned spatially apart to enable determining three-dimensional location information for the one or more fiducial points 112a-f, in an embodiment the system 100 may only include one visible spectrum imaging device which is capable of capturing three-dimensional images of the three-dimensional image 110. For example, the first imaging device 120 may be a LiDAR camera capable of capturing a three-dimensional visible spectrum image of the three-dimensional object 110 without the second imaging device 130.

The third imaging device 140 can be any imaging device capable of capturing images of the three-dimensional object 110 in a domain outside the visible spectrum. For example, the third imaging device 140 may capture images in the near-infrared spectral domain, the short wave infrared spectral domain, the ultra-violet spectral domain, the ultrasound spectral domain, and the radar spectral domain. In an exemplary embodiment, the third imaging device 140 is a thermal image camera, such as, but not limited to, a longwave infrared micro-bolometer camera. While a thermal image camera is used as the primary example, the third imaging device 140 may be a radar imaging device or an ultrasound imaging device, etc.

The third imaging device 140 may be calibrated using known camera calibration techniques based on a calibration pattern specifically designed to provide contrast in both spectral domains of the first imaging device 120, the second imaging device 130, and the third imaging device 140. For example, the third imaging device 140 may be calibrated using a calibration pattern specifically designed to provide both visible and thermal contrast such as, but not limited to a checkerboard pattern. A checkerboard pattern may include a fourteen inch by fourteen inch heating pad with a digital temperature controller sandwiched between two fifteen inch by fifteen inch by one eighth inch aluminum sheets, which are spaced fifteen millimeters apart. The inner surfaces of the two aluminum sheets of the checkerboard pattern in contact with the heating pad are bare metal and the outer surfaces are painted with flat black spray paint. Located fifteen millimeters in front of one black surface is a fifteen inch by twelve inch by 0.093 inch high-impact white styrene sheet. The styrene sheet has an eight inch by ten inch pattern of nominally square twenty millimeter by twenty millimeter holes spaced ten millimeters apart. While the above describes an example calibration pattern, it can be appreciated that any pattern having both visible and thermal contrast may be used to calibrate the third imaging device 140.

The computing device 150 includes, for example, a processor 152, a memory 154, a fiducial point translation program 160, and a graphical user interface 170. The computing device 150 may be a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the first imaging device 120, the second imaging device 130, the third imaging device 140, and the display device 180.

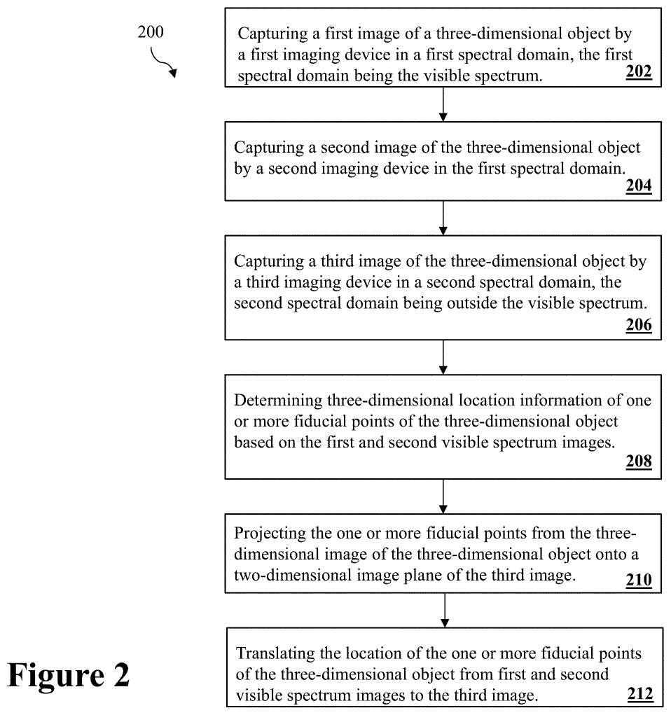

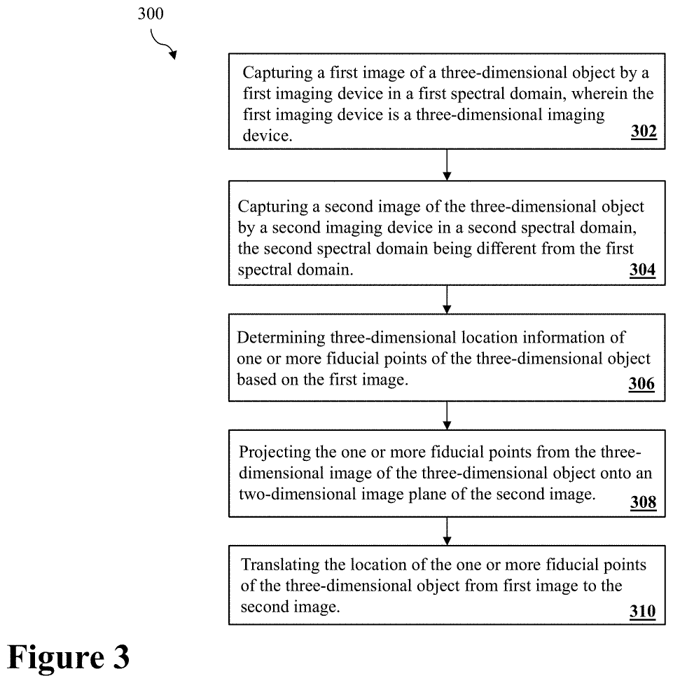

The processor 152 may be a special purpose or a general purpose processor device specifically configured to perform the functions discussed herein. The processor 152 unit or device as discussed herein may be a single processor, a plurality of processors, or combinations thereof. Processor devices may have one or more processor “cores.” In an exemplary embodiment, the processor 152 is configured to perform the functions associated with the modules of the fiducial point translation program 160 as discussed below with reference to FIGS. 2-3.

The memory 154 can be a random access memory, read-only memory, or any other known memory configurations. Further, the memory 154 can include one or more additional memories in some embodiments. In an exemplary embodiment, the memory 154 may include a database of visible-range images of three-dimensional objects, e.g. the three-dimensional object 110, in with manually annotated landmark points, e.g. the one or more fiducial points 112a-f Further, the memory 154 may include a database of images of three-dimensional objects, e.g. the three-dimensional object 110, in other spectral domains outside the visible spectrum by the third imaging device 140. The memory 154 and the one or more additional memories can be read from and/or written to in a well-known manner. In an embodiment, the memory 154 and the one or more additional memories can be non-transitory computer readable recording media. Memory semiconductors (e.g., DRAMs, etc.) can be means for providing software to the computing device 154 such as the fiducial point translation program 160. Computer programs, e.g., computer control logic, can be stored in the memory 154. The memory 154 can be any suitable database configuration, such as a relational database, a structured query language (SQL) database, a distributed database, or an object database, etc. Suitable configurations and storage types will be apparent to persons having skill in the relevant. While the memory 154 is illustrated as part of the computer device 150, it can be appreciated that the memory 154 can be separate from the computer device 150 and communicate with the computing device 150 via any suitable hardwired or wireless network system.

The fiducial point translation program 160 can include image capture module 162, fiducial point determination module 164, fiducial point projection module 166, and fiducial point translation module 168. The fiducial point translation program 160 is a computer program specifically programmed to implement the methods and functions disclosed herein for translating fiducial points of the three-dimensional object 110 from images of the three-dimensional object 110 in a first domain to an image of the three-dimensional object 110 in a second domain. The fiducial point translation program 160 and the modules 162-168 are discussed in more detail below with reference with to FIGS. 2-3.

The graphical user interface 170 can include components used to receive input from the computer device 150, the first imaging device 120, the second imaging device 130, and/or the third imaging device 130, and transmit the input to the fiducial point translation program 160, or conversely to receive information from the fiducial point translation program 160 and display the information on the computing display 180. In an example embodiment, the graphical user interface 170 uses a combination of technologies and devices, such as device drivers, to provide a platform to enable users of computer device 150 and/or the display 180 to interact with the fiducial point translation program 160. In the example embodiment, the graphical user interface 170 receives input from a physical input device, such as a keyboard, mouse, touchpad, touchscreen, camera, microphone, etc. In an exemplary embodiment, the graphical user interface 170 may display the one or more images captured and/or generated by the first imaging device 120, the second imaging device 130, the third imaging device 140, and/or the fiducial point translation program 160.

The display 180 can be any display device capable of receiving display signals from another computing device, such as the computer device 150, and outputting those display signals to a display unit such as, but not limited to, a LCD screen, plasma screen, LED screen, DLP screen, CRT screen, etc. While the display 180 is illustrated separate from the computer device 150, it can be appreciated that the display 180 can be a part of the computer device 150.

The first imaging device 120, the second imaging device 130, the third imaging device 140, the computing device 150, and the display 180 may communicate via any suitable network such as, but not limited to a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. In general, the network can be any combinations of connections and protocols that will support communications between the first imaging device 120, the second imaging device 130, the third imaging device 140, the computing device 150, and display 180.

FIG. 2 illustrates a flowchart of an exemplary method 200 for translating fiducial points in multispectral imagery in accordance with exemplary embodiments.

In an exemplary embodiment, the method 200 can include block 202 for capturing a first image of the three-dimensional object 110 by the first imaging device 120 in a first spectral domain, the first spectral domain being the visible spectrum. For example, the first imaging device 120 may be a monochrome visible-range camera and the three-dimensional object 110 may be a face and the first imaging device 120 may capture an image of the face as illustrated in FIG. 4a. The first image may be captured synchronously with the second and third images of the three-dimensional object 110 described below. In an exemplary embodiment of the system 100, the image capture module 162 can be configured to execute the method of block 202.

In an exemplary embodiment, the method 200 can include block 204 for capturing a second image of the three-dimensional object 110 by a second imaging device 130 in the first spectral domain. For example, the second imaging device 130 may be a monochrome visible-range camera and the three-dimensional object 110 may be a face and the second imaging device 130 may capture an image of the face as illustrated in FIG. 4b. The second image may be captured synchronously with the first and third images of the three-dimensional object 110. In an exemplary embodiment of the system 100, the image capture module 162 can be configured to execute the method of block 204.

In an exemplary embodiment, the method 200 can include block 206 for capturing a third image of the three-dimensional object 110 by a third imaging device 140 in a second spectral domain, the second spectral domain being outside the visible spectrum. For example, the third imaging device 140 may be a LWIR-range micro-bolometer camera and the three-dimensional object 110 may be a face and the third imaging device may capture an image of the face as illustrated in FIG. 4c. The third image may be captured synchronously with the first and second images of the three-dimensional object 110. In an exemplary embodiment of the system 100, the image capture module 162 can be configured to execute the method of block 206.

In an exemplary embodiment, the method 200 can include block 208 for determining three-dimensional location information of one or more fiducial points, e.g. the fiducial points 112, of the three-dimensional object 110 based on the first and second visible spectrum images. The three-dimensional location information of one or more fiducial points 112 of the three-dimensional object 110 may be determined using triangulation, which is also known as parse three-dimensional reconstruction. Triangulation refers to the process of determining the three-dimensional coordinates of a set of points, e.g. the fiducial points 112, in space given the location of their image projections gathered from two or more spatially separated views, e.g. the first image captured by the first imaging device 120 and the second image captured by the second imaging device 130, the knowledge of the intrinsic parameters (including lens distortion parameters) of the first imaging device 120 and the second imaging device 130, e.g. the calibration as discussed above, and the three-dimensional alignment between the first imaging device 120 and the second imaging device 130. For example, the three-dimensional location information of one or more fiducial points of the three-dimensional object may be determined using the Verilook SDK from Neurotechnology, Inc. to generate the visible facial fiducial points. In an exemplary embodiment of the system 100, the fiducial point determination module 164 can be configured to execute the method of block 208.

In an exemplary embodiment, the method 200 can include block 210 for projecting the one or more fiducial points, e.g. the fiducial points 112, from the three-dimensional image of the three-dimensional object onto a two-dimensional image plane of the third image. The one or more fiducial points 112 may be projected onto a two-dimensional plane of the third image using equations 1 and 2 above or using any known open source or commercial software packages for projecting three-dimensional points onto a two-dimensional plane. In an exemplary embodiment of the system 100, the fiducial point projection module 166 can be configured to execute the method of block 210.

In an exemplary embodiment, the method 200 can include block 212 for translating the location of the one or more fiducial points 112 of the three-dimensional object 110 from first and second visible spectrum images to the third image. For example, FIG. 4c illustrates a thermal image with the fiducial points 112 translated from the visible spectrum images of FIGS. 4a-b. In an exemplary embodiment of the system 100, the fiducial point translation module 168 can be configured to execute the method of block 212.

FIG. 3 illustrates a flowchart of an exemplary method 300 for translating fiducial points in multispectral imagery in accordance with exemplary embodiments. In the method 300, a single three-dimensional visible range imaging device is used instead of two visible range imaging devices as in the method 200.

In an exemplary embodiment, the method 300 can include block 302 for capturing a first image of a three-dimensional object by a first imaging device in a first spectral domain, wherein the first imaging device is a three-dimensional imaging device. For example, the first imaging device 120 may be a LiDAR camera and the three-dimensional object 110 may be a face and the first imaging device 120 may capture a three-dimensional image of the face as illustrated in FIG. 4a. The first image may be captured synchronously with the second image of the three-dimensional object 110 described below. In an exemplary embodiment of the system 100, the image capture module 162 can be configured to execute the method of block 302.

In an exemplary embodiment, the method 300 can include block 304 for capturing a second image of the three-dimensional object 110 by a second imaging device 130 in a second spectral domain, the second spectral domain being different from the first spectral domain. For example, the second imaging device 130 may be a LWIR-range micro-bolometer camera and the three-dimensional object 110 may be a face and the second imaging device 130 may capture an image of the face as illustrated in FIG. 4c. In an exemplary embodiment of the system 100, the image capture module 162 can be configured to execute the method of block 304.

In an exemplary embodiment, the method 300 can include block 306 for determining three-dimensional location information of one or more fiducial points 112 of the three-dimensional object 110 based on the first image. The three-dimensional location information of one or more fiducial points 112 of the three-dimensional object 110 may be determined as described above with reference to block 208. In an exemplary embodiment of the system 100, the fiducial point determination module 164 can be configured to execute the method of block 306.

In an exemplary embodiment, the method 300 can include block 308 for projecting the one or more fiducial points 112 from the three-dimensional image of the three-dimensional object 110 onto a two-dimensional image plane of the second image. The one or more fiducial points 112 from the three-dimensional image of the three-dimensional object 110 may be projected onto a two-dimensional image plane of the second image using the method described above with reference to block 210. In an exemplary embodiment of the system 100, the fiducial point projection module 166 can be configured to execute the method of block 308.

In an exemplary embodiment, the method 300 can include block 310 for translating the location of the one or more fiducial points of the three-dimensional object from first image to the second image. For example, FIG. 4c illustrates a thermal image with the fiducial points 112 translated from the visible spectrum image of FIG. 4a. In an exemplary embodiment of the system 100, the fiducial point translation module 168 can be configured to execute the method of block 310.

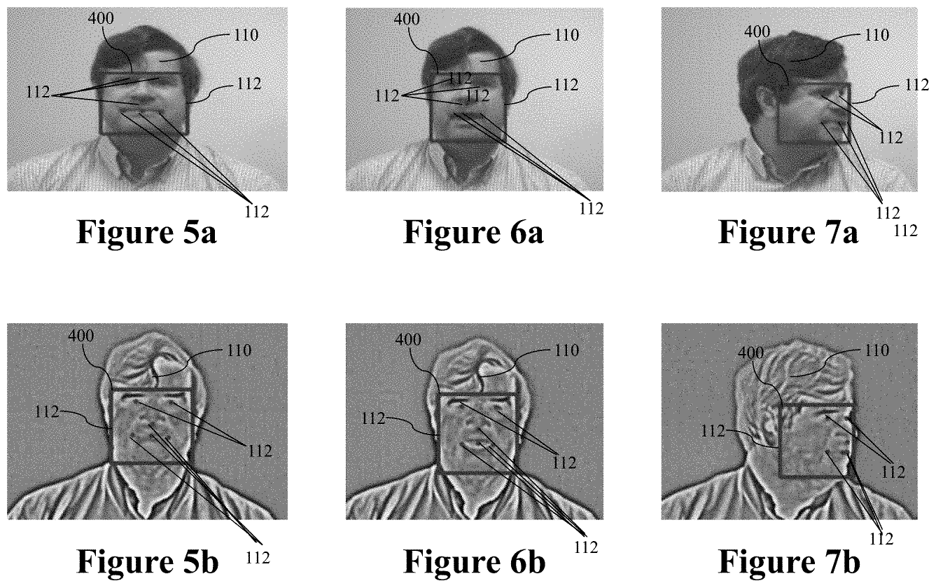

Referring to FIGS. 5a, 6a, and 7a, visible range images of the three-dimensional object 110, e.g. a face, are illustrated with fiducial points 112. FIG. 5a illustrates a face without expression, FIG. 6a illustrates a face with expression, and FIG. 7a illustrates a face in profile view. Referring to FIGS. 5b, 6b, and 7b, corresponding thermal images of the three-dimensional object 110, e.g. a face, in FIGS. 5a, 6a, and 7a, are illustrated with the fiducial points 112 translated from the images of FIGS. 5a, 6a, and 7a in accordance with embodiments of the invention.

A person having ordinary skill in the art would appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, one or more of the disclosed modules can be a hardware processor device with an associated memory.

A hardware processor device as discussed herein can be a single hardware processor, a plurality of hardware processors, or combinations thereof. Hardware processor devices can have one or more processor “cores.” The term “non-transitory computer readable medium” as discussed herein is used to generally refer to tangible media such as a memory device.

Various embodiments of the present disclosure are described in terms of an exemplary computing device. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

A hardware processor, as used herein, can be a special purpose or a general purpose processor device. The hardware processor device can be connected to a communications infrastructure, such as a bus, message queue, network, multi-core message-passing scheme, etc. An exemplary computing device, as used herein, can also include a memory (e.g., random access memory, read-only memory, etc.), and can also include one or more additional memories. The memory and the one or more additional memories can be read from and/or written to in a well-known manner. In an embodiment, the memory and the one or more additional memories can be non-transitory computer readable recording media.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc.

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods illustrated by FIGS. 2 and 3, or similar methods, as discussed herein. Accordingly, such computer programs can represent controllers of the computing device.

Where the present disclosure is implemented using software, the software can be stored in a computer program product or non-transitory computer readable medium and loaded into the computing device using a removable storage drive or communications interface. In an exemplary embodiment, any computing device disclosed herein can also include a display interface that outputs display signals to a display unit, e.g., LCD screen, plasma screen, LED screen, DLP screen, CRT screen, etc.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. A method for translating fiducial points in multispectral imagery, the method comprising:
capturing a first image of a three-dimensional object by a first imaging device in a first spectral domain, the first spectral domain being the visible spectrum;
capturing a second image of the three-dimensional object by a second imaging device in the first spectral domain;
capturing a third image of the three-dimensional object by a third imaging device in a second spectral domain, the second spectral domain being outside the visible spectrum;
determining three-dimensional location information of one or more fiducial points of the three-dimensional object based on the first and second visible spectrum images;
projecting the one or more fiducial points from the three-dimensional image of the three-dimensional object onto a two-dimensional image plane of the third image; and
translating the location of the one or more fiducial points of the three-dimensional object from first and second visible spectrum images to the third image.

2. The method of claim 1, wherein the first and second images and the third image are captured synchronously.

3. The method of claim 1, wherein the first imaging device and the second imaging device are spatially separated.

4. The method of claim 1, wherein the second spectral domain is the thermal spectrum and the third image is a thermal image.

5. The method of claim 1, wherein the second spectral domain is selected from a group consisting of: a near-infrared domain, a short-wave infrared domain, an ultra-violet domain, an ultrasound domain, and a radar domain.

6. The method of claim 1, wherein the three-dimensional location information of one or more fiducial points of the object includes a three-dimensional coordinate location of each one of the one or more fiducial points.

7. The method of claim 1, wherein the object is a human face, and the one or more fiducial points are facial landmarks.

8. The method of claim 4, wherein the first, second, and third imaging devices are calibrated using a calibration board that includes a known pattern of visible and thermal contrast.

9. A method for translating fiducial points in multispectral imagery, the method comprising:
capturing a first image of a three-dimensional object by a first imaging device in a first spectral domain, wherein the first imaging device is a three-dimensional imaging device;
capturing a second image of the three-dimensional object by a second imaging device in a second spectral domain, the second spectral domain being different from the first spectral domain;
determining three-dimensional location information of one or more fiducial points of the three-dimensional object based on the first image;
projecting the one or more fiducial points from the three-dimensional image of the three-dimensional object onto an two-dimensional image plane of the second image; and
translating the location of the one or more fiducial points of the three-dimensional object from first image to the second image.

10. The method of claim 9, wherein the three-dimensional imaging device is a LiDAR camera.

11. The method of claim 9, wherein the first image and the second image are captured synchronously.

12. A system for translating fiducial points in multispectral imagery, the system comprising:
a first imaging device in a first spectral domain configured to capture a first image of a three-dimensional object, the first spectral domain being the visible spectrum;
a second imaging device in the first spectral domain configured to capture a second image of the three-dimensional object;
a third imaging device in a second spectral domain configured to capture a third image of the three-dimensional object, the second spectral domain being outside the visible spectrum; and
a processor configured to:
determine three-dimensional location information of one or more fiducial points of the three-dimensional object based on the first and second visible spectrum images,
project the one or more fiducial points from the three-dimensional image of the three-dimensional object onto an two-dimensional image plane of the third image, and
translate the location of the one or more fiducial points of the three-dimensional object from first and second visible spectrum images to the third image.

13. The system of claim 12, wherein the first and second images and the third image are captured synchronously.

14. The system of claim 12, wherein the first imaging device and the second imaging device are spatially separated.

15. The system of claim 12, wherein the second spectral domain is the thermal spectrum and the third image is a thermal image.

16. The system of claim 12, wherein the second spectral domain is selected from a group consisting of: a near-infrared domain, a short wave infrared domain, an ultra-violet domain, an ultrasound domain, and a radar domain.

17. The system of claim 12, wherein the three-dimensional location information of one or more fiducial points of the object includes a three-dimensional coordinate location of each one of the one or more fiducial points.

18. The system of claim 12, wherein the object is a human face, and the one or more fiducial points are facial landmarks.

19. The system of claim 15, wherein the first, second, and third imaging devices are calibrated using a calibration board that includes a known pattern of visible and thermal contrast.

20. A system for translating fiducial points in multispectral imagery, the system comprising:
a first imaging device in a first spectral domain configured to capture a first image of a three-dimensional object, the first spectral domain being the visible spectrum, and the first imaging device being a three-dimensional imaging device;
a second imaging device in a second spectral domain configured to capture a second image of the three-dimensional object, the second spectral domain being different from the first spectral domain; and
a processor configured to:
determine three-dimensional location information of one or more fiducial points of the three-dimensional object based on the first image,
project the one or more fiducial points from the three-dimensional image of the three-dimensional object onto an two-dimensional image plane of the second image, and
translate the location of the one or more fiducial points of the three-dimensional object from first image to the second image.

21. The system of claim 20, wherein the three-dimensional imaging device is a LiDAR camera.

22. The system of claim 20, wherein the first image and the second image are captured synchronously.
